(19) United States
(12) Patent Application Publication
(10) Pub. No.: US 2016/0364398 A1
(43) Pub. Date: Dec. 15, 2016

(54) GENERATION AND DYNAMIC SERVING OF DEVICE-DEPENDENT WEB CONTENT

(71) Applicant: Undelay Inc., Phoenix, AZ (US)

(72) Inventors: Peter Nelson, Phoenix, AZ (US); Nicole Wallace, Phoenix, AZ (US); Estil Wallace, Phoenix, AZ (US)

(73) Assignee: Undelay Inc.

(21) Appl. No.: 15/178,975

(22) Filed: Jun. 10, 2016

Related U.S. Application Data
(60) Provisional application No. 62/173,651, filed on Jun. 10, 2015.

(51) Int. Cl. G06F 17/30; G06F 3/0482; H04L 29/08

(52) U.S. Cl. CPC G06F 17/3089; H04L 67/02; G06F 17/30864; G06F 3/0482

(57) ABSTRACT

A web content builder tool is provided for rapidly creating multiple related web content layouts for dynamic serving to devices having, e.g., different form factors. Layouts can be selectably linked or unlinked. While linked, adding content items to one layout causes automatic propagation of family member content items to the other layouts, and changing content item attributes within one layout causes automatic propagation of changes to family member content items in other layouts. While unlinked, adding or changing content items in one layout does not automatically cause changes to other layouts.

### TECHNICAL FIELD

The present disclosure relates in general to information retrieval in a computer network, and in particular to the creation and dynamic serving of user device-dependent web content.

### BACKGROUND

The World Wide Web is a multimedia retrieval system in which client machines conduct transactions with Web servers via the Internet. The Hypertext Transfer Protocol (HTTP) is commonly used to provide users with access to files (such as text, graphics, images, sound, video and the like) using a standard page description known as Hypertext Markup Language (HTML). HTML provides basic document formatting and may include links to other servers and files.

In the past, the World Wide Web was typically accessed from desktop or laptop computers. However, in recent years, other types of devices capable of Internet access have become increasingly prevalent. Examples of such devices that may be used for accessing the Web include smartphones, handheld media players, tablet computers, smart watches, smart glasses, home appliances and in-automobile computing devices. However, as a result of the variety and prevalence of devices from which Web content is accessed, users consume content on a wide variety of display sizes and form factors.

Content formatted for large displays, such as a desktop or laptop computer display, may be difficult to access or comprehend on a device having a display with a substantially different form factor. As a result, some web content providers have designed separate, “mobile” versions of their web sites, optimized for display on smart phones or other small form factor devices. Such mobile sites are often simplified in layout and content, and may feature reduced file size to enable rapid loading over sometimes-constrained mobile device network bandwidth, or rapid rendering by devices that may have limited processing power.

In recent years, another approach to serving content to mobile devices has gained popularity, often referred to as responsive design. Sites utilizing responsive design are typically built with containerized content. Content containers are automatically reorganized within a display window, based on the display size of the device rendering the content. In this way, a single responsive design web site can be rendered on a wide variety of display form factors in a predictable and comprehensible manner, while a web content publisher need only maintain one version of its web content. However, web sites using responsive design typically require serving of specialized code that, when executed on a client device web browser, enables the client-side dynamic content reconfiguration. This responsive code may increase the volume of data that must be downloaded by client devices, thereby increasing page download times and client device battery consumption. The responsive code may also impose greater processing load on client device processors when rendered by the client web browser, again reducing device battery life (for mobile devices) and/or increasing site latency and page rendering times. The end result provides some level of content optimization by device type, but is often still constrained in its design flexibility, giving rise to a predominant look and feel for responsive design sites that may appear derivative in nature.

Another approach which addresses the overhead and flexibility limitations of responsive web design is dynamic serving. Servers with dynamic serving capabilities may automatically detect a user's device type and serve a version of the web content optimized for the device type. Such dynamic serving models provide high levels of design flexibility, so that content presentation can be optimized for each client device type. Also, mobile and tablet designs can be optimized to minimize page load size and browser rendering overhead for faster user interaction. However, dynamic serving models typically require the development of multiple independent designs, and specialized developer skills. Such implementations therefore require additional time and resources for building, deploying, hosting and maintaining multiple versions of a site. This can be particularly burdensome for web content developers creating advertising and market campaign content, which may need to be generated quickly, with a limited budget, and sometimes utilized for only a limited period of time.

### SUMMARY

In accordance with some embodiments, a web content builder tool is provided for rapidly, efficiently generating multiple related web content layouts for dynamic serving environments. The tool can be used to generate content layouts customized to, e.g., client device form factor, such as personal computer, tablet or mobile phone. The layouts can be selectably linked or unlinked by the user, such as via selection of a link indicia within a builder tool user interface. While linked, when content items are added to one of the layouts, family members of the added content item are automatically propagated to the remaining layouts. Also, while linked, changes to attributes of a content item on one layout (e.g. size, color, position) can be automatically propagated to family members of that content item on remaining layouts. While unlinked, additions, deletions or changes to content items in one layout are not automatically propagated to family members on other layouts.

In some circumstances, automatic propagation of family members and/or attribute changes may be performed on a modified basis, depending on characteristics of the layout onto which the propagation takes place. For example, an added image may be automatically resized proportionately to the display area of the layout to which the image is propagated. Similarly, changes to the size of an existing content item may be applied to family members proportionately to the display area of the layout within which the family member resides.

A manual content item propagation mechanism can also be provided within a web content builder tool with which a user can selectively, manually propagate a content item to selected layouts, even while the layouts are unlinked.

The resulting web content layouts can then be served dynamically by a web server. Metadata associated with an inbound query for web content may be evaluated by the web server to identify which of multiple preconfigured web content layouts should be served in response. For example, an inbound query may include metadata describing the display window size of the client device. The web server may utilize that metadata to determine whether the display window size of the client device most closely corresponds to a personal computer display, a tablet computer display or a mobile phone display; and the web server can respond by serving an associated content layout.

### BRIEF DESCRIPTION OF THE DRAWINGS

FIG. 1 is a schematic block diagram of a computing environment.

FIG. 2 is a schematic block diagram of a client computing device.

FIG. 3 is a schematic block diagram of a server.

FIGS. 4A, 4B, 4C, 4D, and 4E are schematic block diagrams of linked and unlinked device-specific web content layouts.

FIG. 5 is a process for generating device-specific web content for dynamic serving.

FIGS. 6, 7, 8, 9, 10, 11 and 12 are graphical user interfaces for content builder tools.

FIG. 13 is a process for dynamic serving of web content.

FIG. 14 is a process for using a manual content item propagation mechanism.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

In accordance with some embodiments, a dynamic serving environment is described in which device-specific versions of web sites can be rapidly created, deployed and modified, while maximizing content and layout reuse between sites.

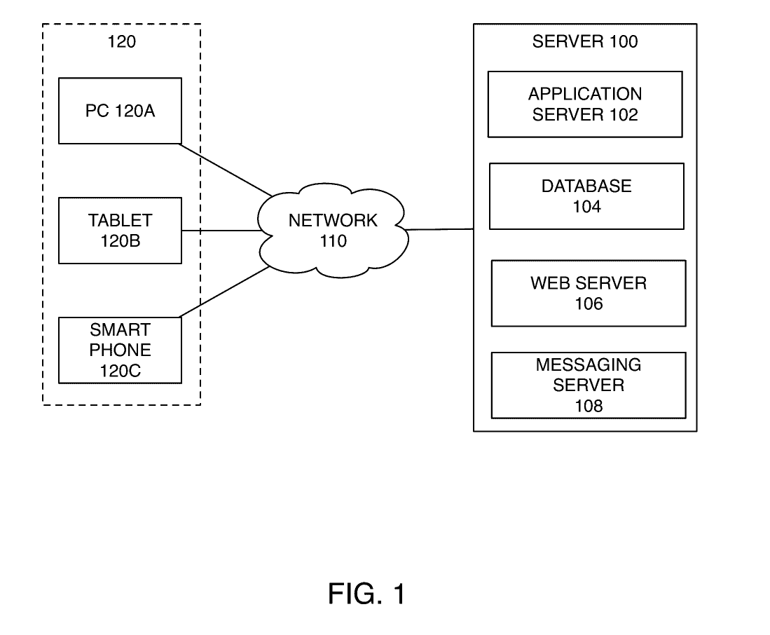

FIG. 1 is a schematic block diagram of a computing environment in which some embodiments described herein can be implemented. Server 100 communicates with client computing devices 120 via data network 110, which may include the Internet. Clients 120 include personal computer 120A, tablet computer 120B and smart phone 120C. While FIG. 1 illustrates three client devices 120, it is contemplated and understood that implementations may involve large numbers and types of client devices.

Server 100 implements web services and other applications. The embodiment of FIG. 1 includes application server 102, database 104, web server 106 and messaging server 108. While depicted in the schematic block diagrams as a block element with specific sub-elements, as known in the art of modern web applications and network services, server 100 may be implemented in a variety of ways, including via distributed hardware and software resources and using any of multiple different software stacks. Server 100 may include a variety of physical, functional and/or logical components such as one or more each of web servers, application servers, database servers, email servers, storage servers, SMS or other instant messaging servers, and the like. That said, the implementation of server 100 will include at some level one or more physical servers, at least one of the physical servers having one or more microprocessors and digital memory for, inter alia, storing instructions which, when executed by the processor, cause the server to perform methods and operations described herein.

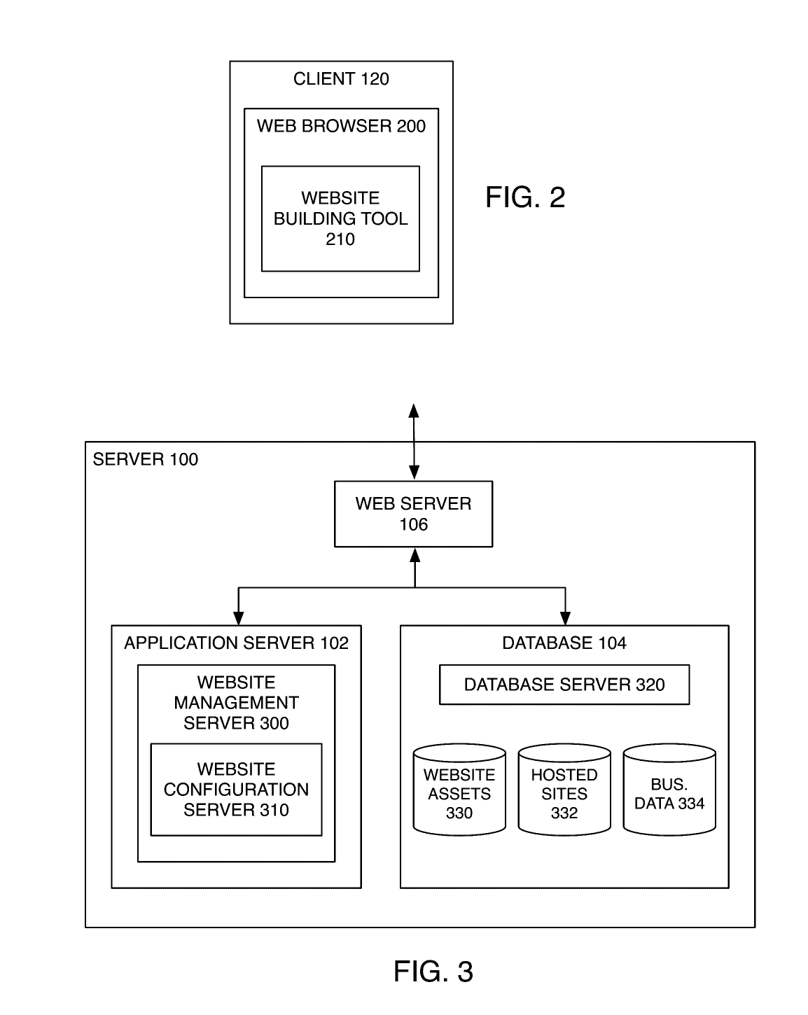

FIG. 2 is a schematic block diagram of a client computing device. Client 120 includes web browser 200. In some use cases, web browser 200 can be utilized to access and display web content dynamically served by server 100. In other use cases and embodiments, client web browser 200 can be utilized to efficiently build web sites customized for multiple client device form factors. In such embodiments, client web browser 200 downloads code to implement website building tool 210, which interacts with, inter alia, website configure server 310 (FIG. 3).

FIG. 3 is a schematic block diagram of server 100. Web server 106 communicates externally via network 110. Application server 102 implements website management server 300, and website configuration server 310, which together may be utilized by client devices such as device 120 of FIG. 2 in order to build, deploy and modify dynamically-served, device-specific web content. Sever 100 further implements database 104, which includes database server 320 facilitating access to, inter alia, website assets database 330, hosted sites database 332, and hosting business data database 334.

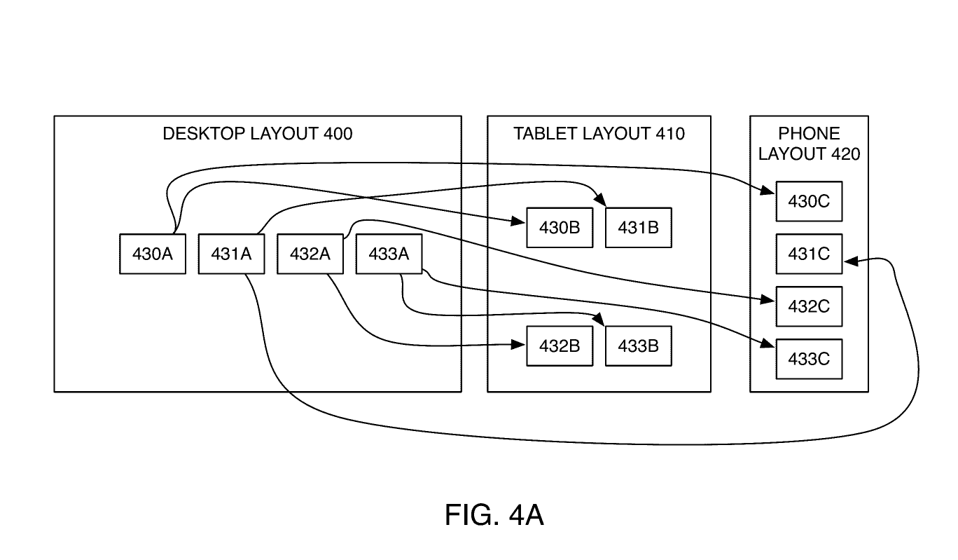

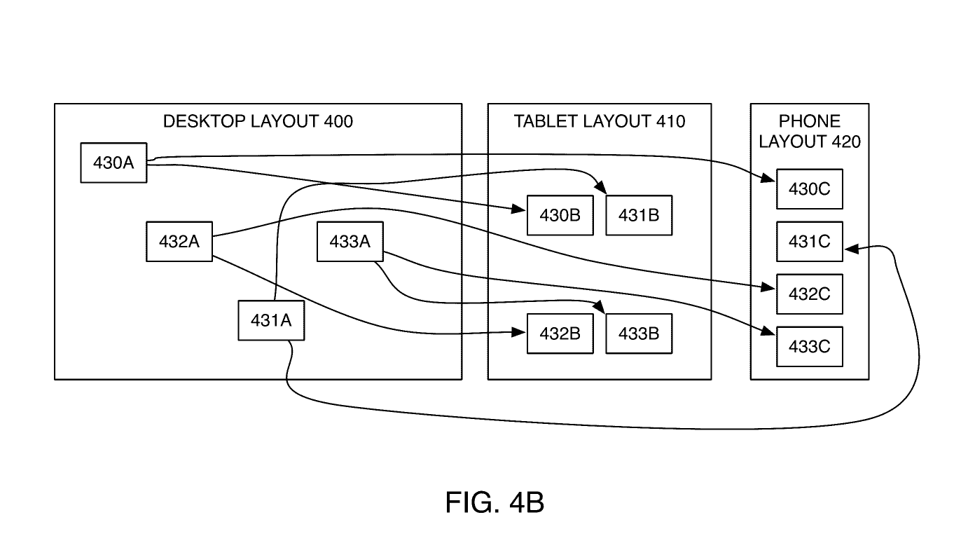

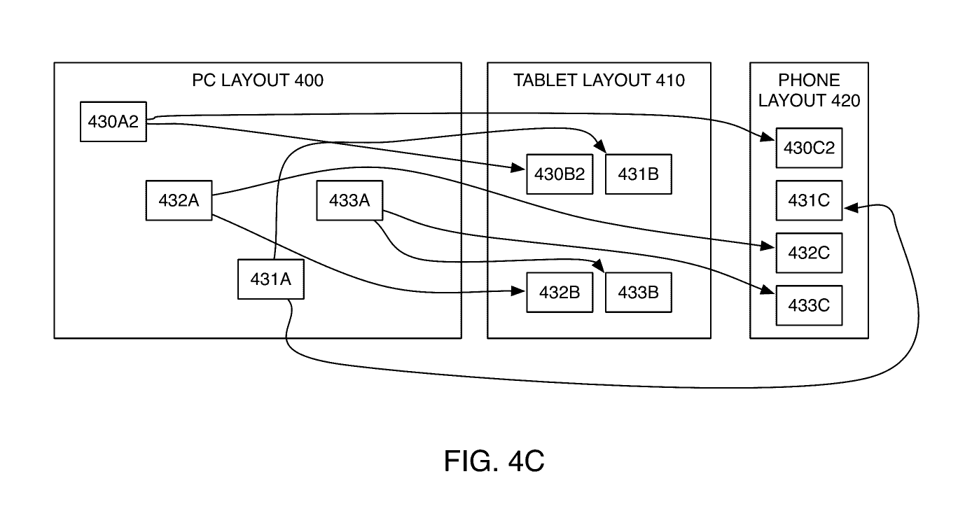

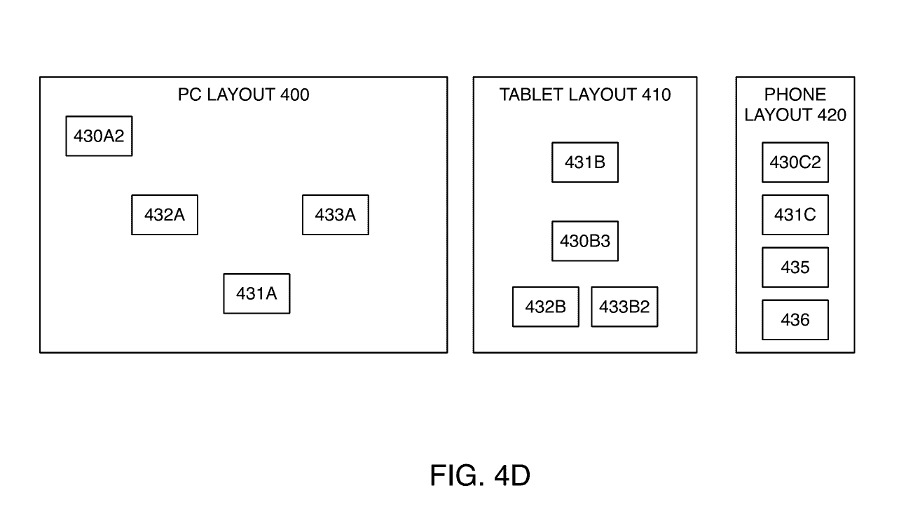

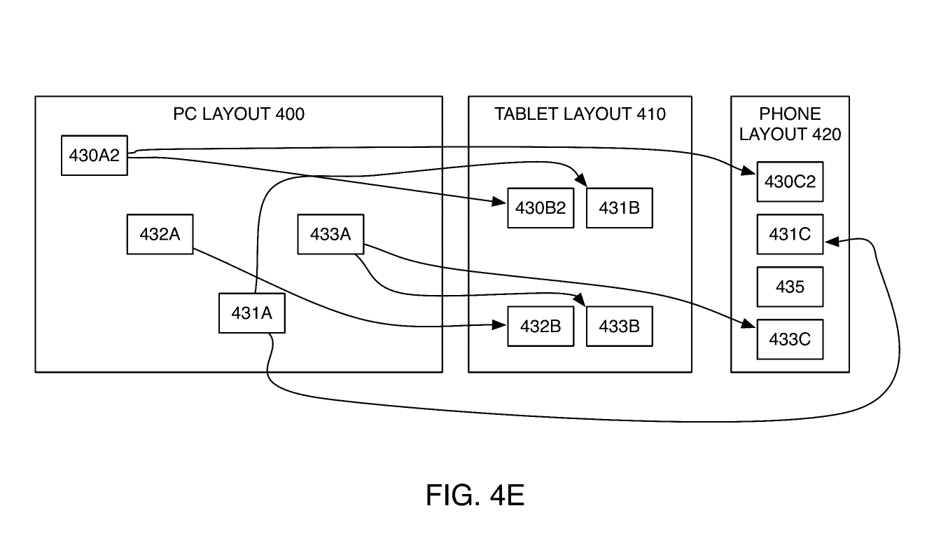

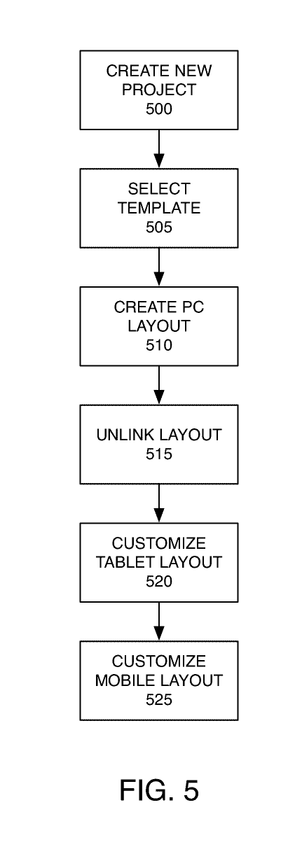

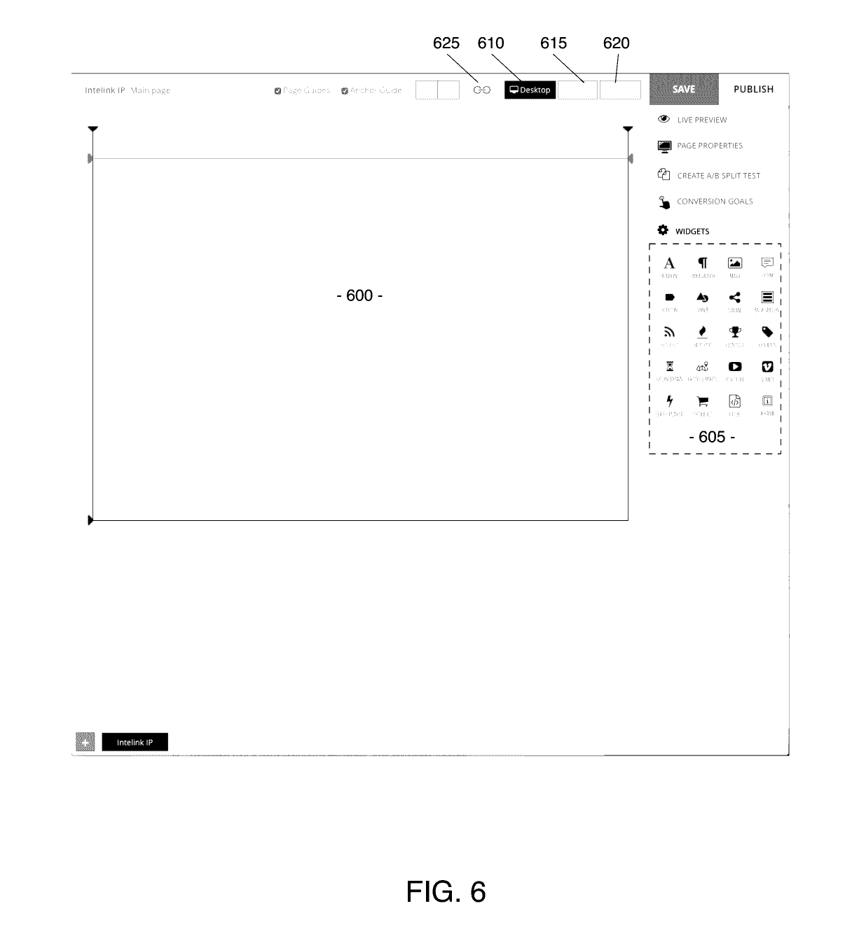

FIGS. 4A, 4B, 4C and 4D schematically illustrate a series of device-specific web content layouts that can be built using website building tool 210 interacting with server 100. FIG. 5 is a flow chart illustrating a process for preparing the device-specific web content layouts of FIGS. 4A-4D, in accordance with one embodiment. FIGS. 6-12 illustrate exemplary user interfaces that may be rendered by website building tool 210, in order to implement the functionality of FIGS. 4A-4D and 5.

In step 500, a user creates a new project, such as via selection of a CREATE NEW PROJECT button within a user interface rendered by website building tool 210. Optionally, a predetermined template can be selected (step 505). Preferably, such templates include a set of multiple web content layouts customized for different devices (such as smartphone, tablet and personal computer) but having consistent theme and user interactions. Whether starting from a template or a blank layout, in step 510, a user creates a first web content layout.

FIG. 6 illustrates a content creation user interface that may be rendered on a user device by website building tool 210 in order to create a web layout in step 510. Content region 600 provides space in which web content can be created. Widget region 605 contain predetermined web content widgets (i.e. content items) that can be arranged within content region 600, such as via a drag-and-drop user interface. Content within region 600 can then be customized. Desktop button 610 is selected, indicating that the desktop version of the web content is presently being viewed and edited within content region 600. Tablet button 615 enables a user to toggle to view and edit a tablet version of the current web content within content region 600, while Mobile button 620 can be selected to view and edit a mobile version of the current web content within content region 600.

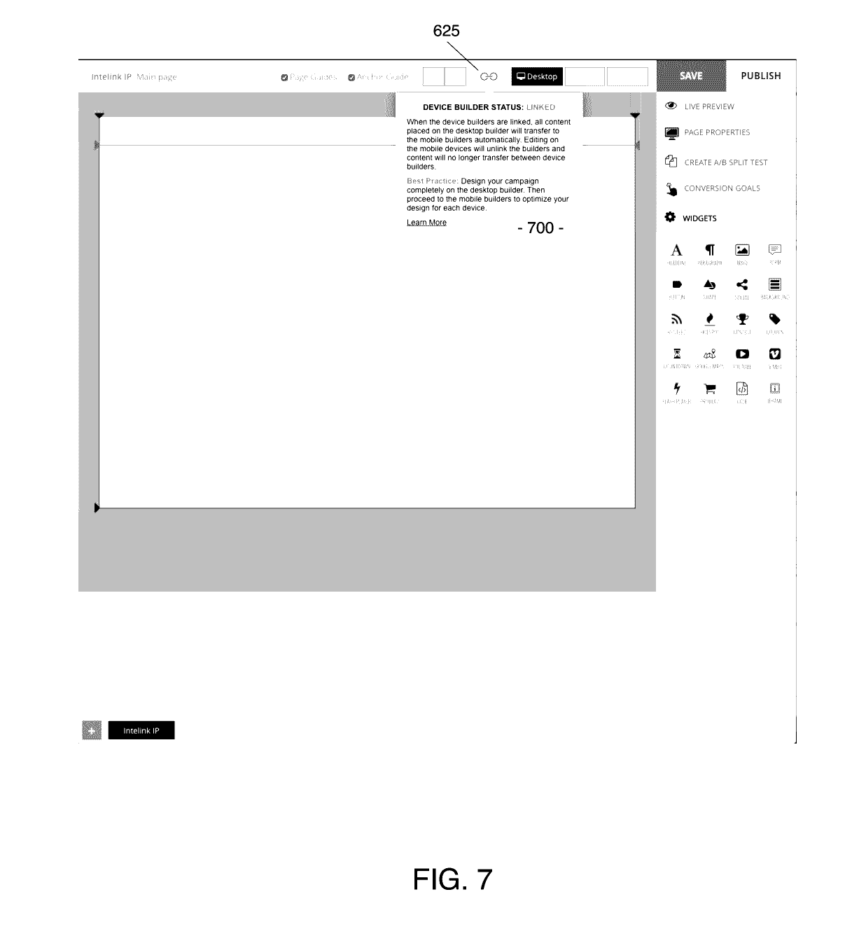

Link icon 625 indicates to a user that the desktop, tablet and mobile layouts are currently linked. When layouts are linked, content will be synchronized across the various form factor layouts. Thus, new content items added to content region 600 in the desktop layout, will also be placed within the tablet and mobile layouts. Edits to content items in the desktop layout, will also be reflected in the tablet and mobile layouts. FIG. 7 illustrates the user interface of FIG. 6, when the user hovers a selection cursor over link icon 625, with explanatory popup message 700 being displayed.

Schematically, FIGS. 4A-4D illustrate the operation of content linking across device-specific layouts. FIG. 4A includes desktop layout 400, tablet layout 410 and phone layout 420. (While sometimes referred to herein as a “desktop layout”, it is contemplated and understand that desktop layouts may also be serviced to other PCs such as laptop computers, and possibly even to other devices running full personal computer operating systems.) When a user creates desktop layout 400, having content items 430A, 431A, 432A and 433A, server 100 operates to automatically generate tablet layout 410 having content items 430B, 431B, 432B and 433B, linked to content items 430A, 431A, 432A and 433A, respectively. Server 100 further operates to automatically generate mobile layout 420 having content items 430C, 431C, 432C and 433C, also linked to content items 430A, 431A, 432A and 433A, respectively. Lines interconnecting the various content items in FIG. 4A indicate linking of the content items such that, e.g., changes to desktop content item 430A are automatically propagated to tablet content item 430B and mobile phone content item 430C. In some embodiments, linked content items are based on the same underlying assets (such as image files or text content blocks). In some embodiments, linked content items are rendered identically across desktop, tablet and mobile phone layouts. In other embodiments, some or all linked content items are rendered in a manner specific to the target device form factor, such as downsampling or cropping of large images from a desktop layout to a mobile layout, or wrapping text within a text pane sized for the particular device display.

FIG. 4B shows that, in some embodiments, content items can be repositioned within one layout (e.g. desktop layout 400), without disrupting the rendering of linked content items in layouts 410 and 420. Thus, the content items may be associated with a first set of properties that are not propagated across layouts (e.g. location within a given layout display area), and a second set of properties that are propagated across layouts when the layouts are linked (e.g. text content, text color, and image selection). When content items are linked, modifying a content item within one of the layouts causes that content items to be updated within the other linked layouts, if the modification is directed to a property that is subject to propagation when linked. For example, in FIG. 4C, a user has substituted modified content item 430A2 in lieu of original content item 430A. Server 100 operates to update the linked content items within tablet layout 410 (updating to content item 430B2) and mobile layout 420 (updating to content item 430C2).

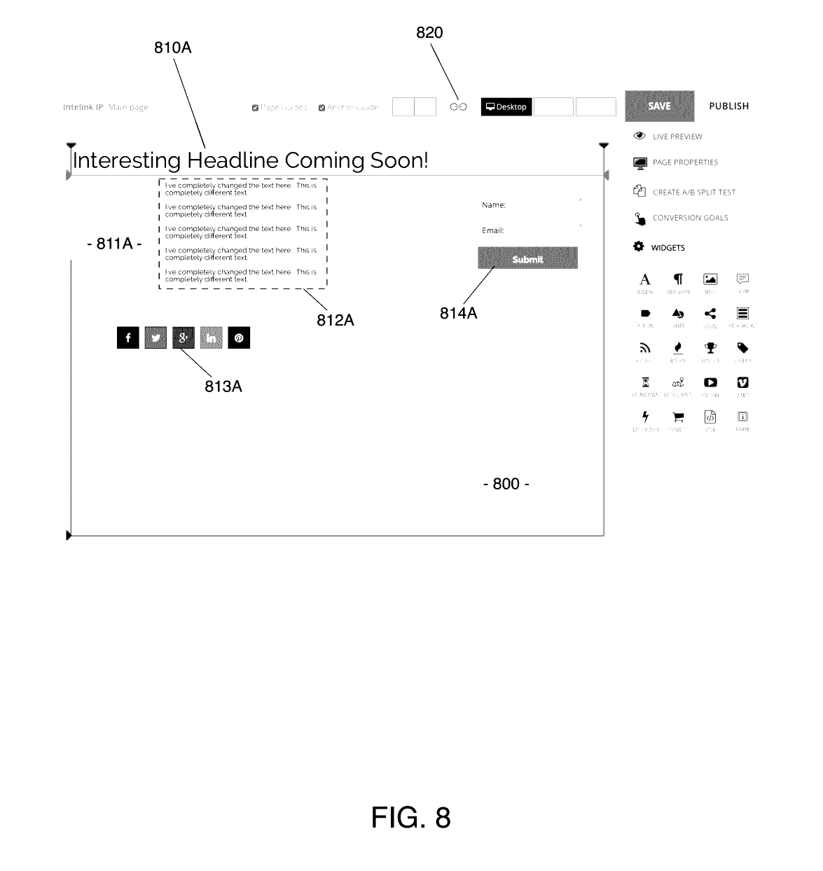

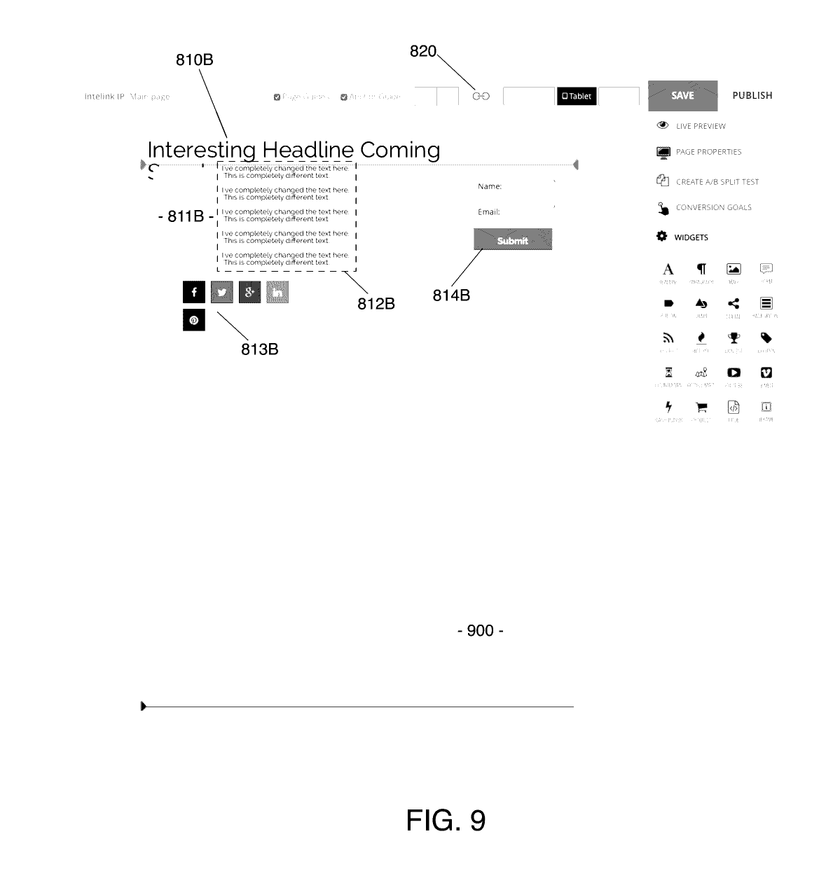

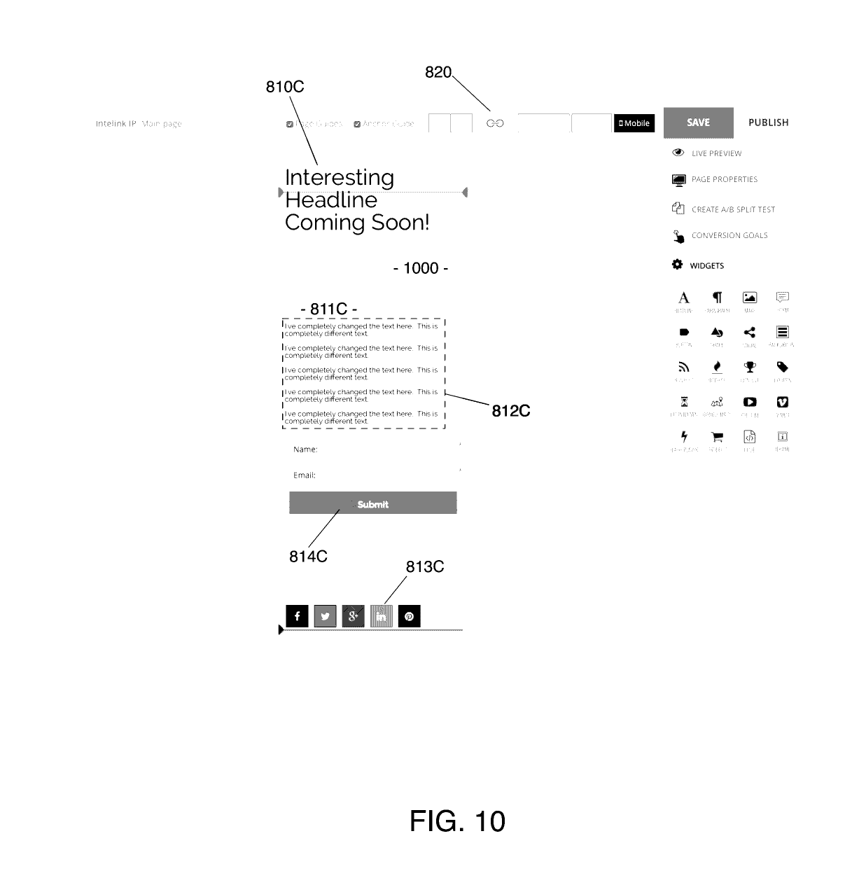

In FIG. 8, desktop content region 800 includes content items headline 810A, image 811A, text block 812A, social sharing buttons 813A and call to action form 814A. Icon 820 confirms that the desktop, tablet and mobile layouts are linked. FIG. 9 illustrates the automatically-generated tablet layout corresponding to the desktop layout of FIG. 8. The tablet layout is rendered within tablet content region 900, and is determined by server 100 and application server 102 applying predetermined layout rules to user-specified content items. The predetermined rules may be default rules (e.g. mapping desktop content items proportionally to locations within a smaller display area) or rules associated with a predetermined template selected by the user. Tablet content items include headline 810B, image 811B, text block 812B, social sharing buttons 813B and call to action form 814B, linked with content items headline 810A, image 811A, text block 812A, social sharing buttons 813A and call to action form 814A, respectively. FIG. 10 illustrates the automatically-generated mobile layout rendered within mobile content region 1000 and corresponding to the desktop layout of FIG. 8, similarly derived by applying predetermined layout rules to user-specified content items. Content items within content region 1000 include headline 810C, image 811C, text block 812C, social sharing buttons 813C and call to action form 814C, linked with content items headline 810A, image 811A, text block 812A, social sharing buttons 813A and call to action form 814A, respectively. Thus, for example, modification of text within any one of content items 812A, 812B or 812C, will automatically update the text content of the other, linked content items 812.

By creating an initial content layout in step 510 (process of FIG. 5), server 100 automatically generates separate (but linked) web content for other device form factors. Thus, for example, by creating web content for a desktop display, server 100 automatically generates separate (but optionally linked) versions adapted for tablet and mobile displays. The separate versions can then each be stored within hosted sites database 332 and served dynamically by web server 106.

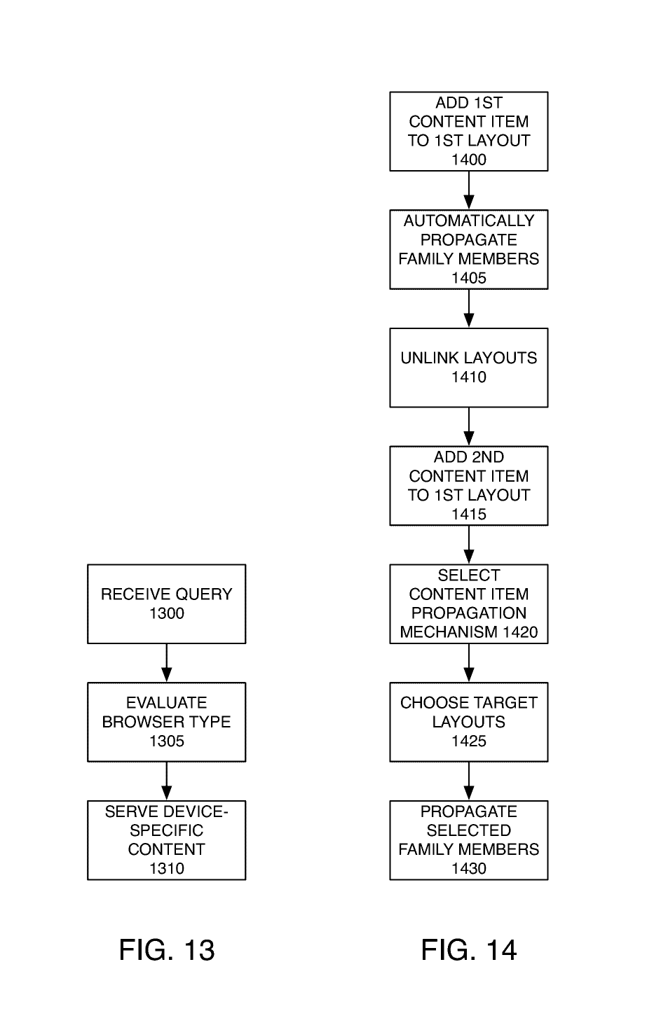

FIG. 13 illustrates an exemplary process through which web server 106 serves content generated in the process of FIG. 5. In step 1300, server 100 (particularly web server 106) receives a query for web content from a user device 120 via network 110. In step 1305, web server 106 evaluates metadata provided within the query of step 1300 in order to identify which of multiple content layouts should be served in response to the query (e.g. by evaluating one or more metadata items specifying browser type, display size, handheld device, touchscreen display type, or the like). In step 1310, web server 106 replies, retrieving web content corresponding to the browser type identified in step 1305 (desktop/personal computer, tablet or mobile) from database 332 and transmitting it to user device 120 via network 110. While the serving embodiment of FIG. 13 contemplates basic retrieval and transmission of static web content, it is contemplated and understood that other embodiments may be implemented without departing from the scope or spirit of the invention, including embodiments in which a device-specific web application is served to dynamically generate content created as described elsewhere herein.

While automated generation of independent web content formatted for different device form factors may be beneficial in facilitating a dynamic serving model of user device optimization, in some circumstances, it may be desirable for a content creator to customize content items for a particular form factor. For example, in a marketing content piece, a larger personal computer display may enable presentation of a significant amount of persuasive marketing content prior to (e.g. above) presentation of a call-to-action button. However, on a mobile device, presentation of the same marketing content within a narrow mobile phone display may result in the call-to-action button being presented only after a user engages in a significant amount of scrolling, such that many users leave the web content before ever reaching the call-to-action button. In such an example, it may be desirable to, e.g., eliminate or downsize image content, substitute shorter text content, and/or reposition the call-to-action button above (i.e. before) other content items. Embodiments described herein can provide the speed and efficiency benefits of automated device-specific web content composition for dynamic serving, while also enabling customization of each composition to optimize for form factor.

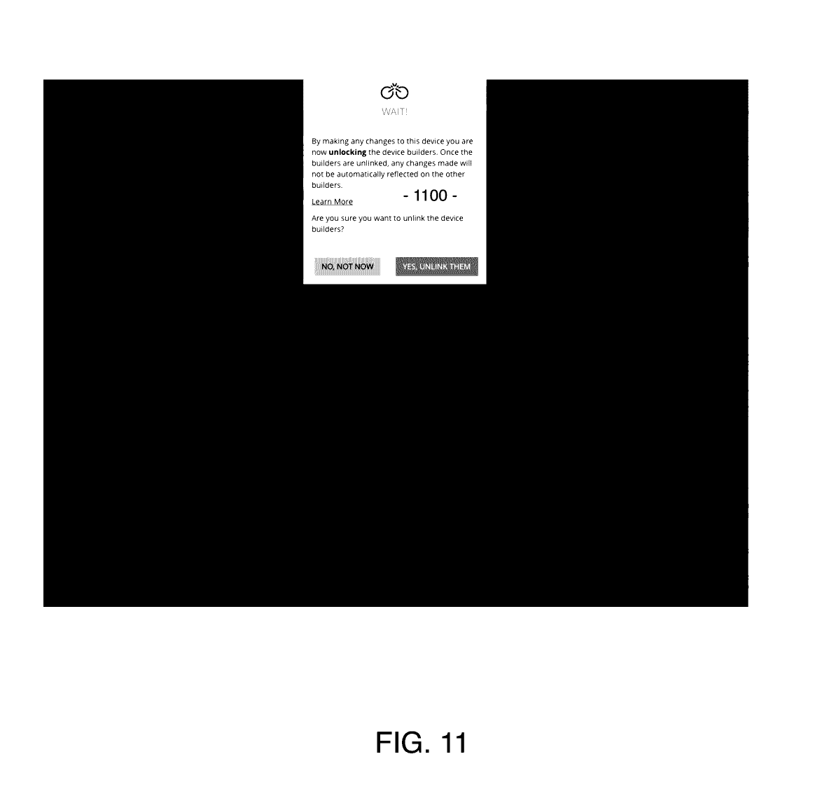

To that end, in step 515 of the process of FIG. 5, a user can unlink the layouts. In the embodiment of FIGS. 8-10, the layouts can be unlinked via selection of icon 820. Preferably, the user is provided with an explanatory notice of the impact of unlinking the layouts, as illustrated in FIG. 11 via confirmation popup 1100. Once the layouts are unlinked, a user can customize device specific layouts, using the automatically-generated layout as a starting point, without modifying the other unlinked layouts. For example, in the workflow of FIG. 5, once the user has created a personal computer layout in step 510 and unlinked the automatically-generated tablet and mobile layouts in step 515, the user can subsequently optimize the tablet layout for the tablet form factor (step 520), and optimize the mobile layout for the mobile form factor (step 525).

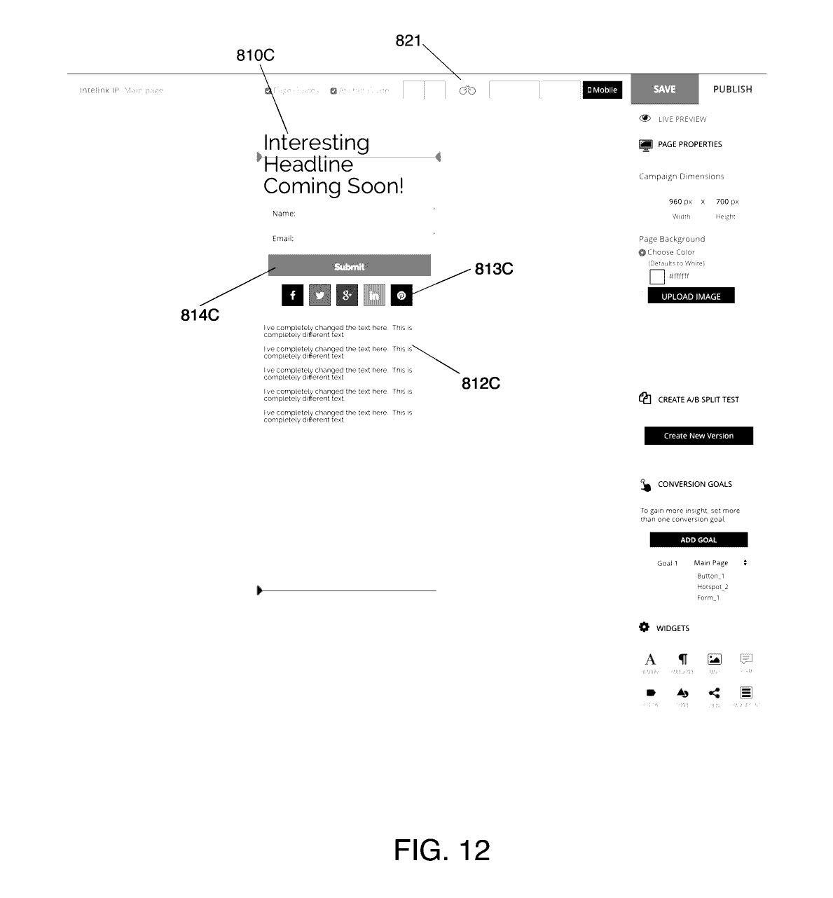

FIG. 12 illustrates a mobile layout builder user interface rendered in response to unlinking in step 515. Compared to the automatically-generated mobile layout of FIG. 10, in the customized unlinked layout of FIG. 12, image 811C has been removed, and text content 812C has been moved below signup form call to action 814C and social sharing buttons 813C. Broken chain links icon 821 has been substituted for linked icon 820, providing the user with an indicia conveying that device-specific layout builders have been unlinked. However, the personal computer and tablet layouts of FIGS. 8 and 9 remain unchanged.

In some embodiments, the impact of unlinking device-specific builders is illustrated in the schematic representations of FIG. 4 by FIG. 4D. Links have been removed, such that content items in any particular layout can be moved, modified, deleted or added, without impacting the other layouts. In the example of the unlinked layouts of FIG. 4D compared to the prior, linked layouts of FIG. 4C: in tablet layout 410, content items have been repositioned and content item 430B2 has been replaced by modified content item 430B3, content item 433B has been replaced by content item 433B2; in phone layout 420, content items 432C and 433C have been replaced by content items 435 and 436, respectively.

In the embodiment of FIG. 4D, an unlinking action impacts all layout content items simultaneously; thus, the device-specific layouts as a whole are either linked or unlinked. Such an embodiment provides a simple, readily-understood analogy for users to understand whether and how modification of one device-specific layout impacts others. However, in other embodiments, it may be desirable to enable content-item specific linking and unlinking. In such embodiments, website building tool 210 may interact with server 100 to enable users to readily link or unlink individual content items, whereby modification of linked content items in one layout may cause automated propagation of analogous changes to linked content items in other device-specific layouts, while simultaneous modification of unlinked content items in one layout may not cause changes to other device-specific layouts. Optionally, in such embodiments enabling content item-specific linking and unlinking, a global link/unlink control may still be provided in the event that a user desires to simultaneously link or unlink all content items present within a particular web content layout.

FIG. 4E illustrates an exemplary content item-specific unlinking operation within such an embodiment. In FIG. 4E, compared to the condition reflected in FIG. 4C, content item 432C within mobile layout 420 has been unlinked, deleted, and substituted with content item 435. However, remaining content items 430, 431 and 433 remain linked, such that changes to those content items made within any of layouts 400, 410 and 420 are automatically propagated to their linked counterparts in the other layouts. In such an embodiment as FIG. 4E, device-specific layouts may be customized while still enabling rapid and efficient content updating across layouts. For example, text copy may be linked for rapid updating and revision across all layouts simultaneously, while a call-to-action may be unlinked, enabling device-specific optimization.

Users may be provided with an option to re-link layouts, after they have previously been unlinked. In some embodiments, when layouts are re-linked after having been unlinked, application logic 102 operates to identify content items in a common family, such as content items newly added while the layouts are linked and automatically propagated across layouts. Upon being re-linked, changes to attributes of one member of a content item family are automatically propagated to other members of the family. For example, if layouts are re-linked and a button content item in one layout is changed in color from red to blue, content items in the same family (i.e. instances of that button propagated to other layouts at a time when the layouts were linked) are also changed in color from red to blue; however, any other attribute changes made while the layouts are unlinked (e.g. resizing, position changes) remain unique to each layout. In some embodiments, certain attribute changes may not be propagated after re-linking; for example, it may be desirable to stop propagating position changes between layouts after layouts have been unlinked and manually arranged. In some embodiments, certain attribute changes may be propagated on a modified basis, such as a relative basis; for example, it may be desirable to propagate widget size changes on a relative or percent-change basis.

Typically, adding a content item while layouts are linked will automatically propagate related content items to other layouts, while adding a content item while layouts are unlinked will generate the content item within only the layout to which the content items is added. However, in some circumstances, it may be desirable to provide a selectable content item propagation mechanism. The selectable content item propagation mechanism can be utilized by a user to readily trigger the propagation of content item family members from the current layout to a selected one or more other layouts, even when the layouts are unlinked. For example, a user may wish to add a content item to large-screen layouts but omit the content item from a small-screen mobile phone layout.

FIG. 14 describes a process by which content items can be selectively propagated automatically or manually between multiple layouts. Initially, layouts are linked. In step 1400, a first content item is added to a first one of multiple layouts using website building tool 210 interacting with website configuration server 310. Because the layouts are linked, in step 1405, new family members of the first content item are automatically propagated to each of the remaining layouts. In step 1410, layouts are unlinked via, e.g., selection of indicia 625. In step 1415, a second content item is added to one of the layouts (e.g. a widget from widget selection region 605 is dragged-and-dropped into one of content editing areas 800, 900 or 1000). In step 1420, a content item propagation mechanism is selected for the newly-added content item. For example, in an exemplary embodiment, the second content item can be right-clicked to yield a context-sensitive popup menu having, inter alia, an “Add to . . . ” menu item. Selection of the “Add to . . . ” item yields a multi-select list of available layouts in the current project. One or more layouts may be selected in step 1425. In step 1430, website configuration server 310 operates to propagate new family members of the second content item only into the layouts selected in step 1425, and those family members are rendered for the user by website building tool 210.

While certain embodiments may enable creation and management of three different layouts (desktop, tablet and mobile phone), it is contemplated and understood that other embodiments could provide for a greater or lesser number of layouts. For example, in some embodiments, two layouts may be provided, such as “large display” (desktop and large tablets) and “small display” (mini tablets and mobile phones). In other embodiments, different layouts may be provided for serving based on attributes other than (or in addition to) device size, such as whether the device provides a touchscreen display or whether the device relies on keyboard and mouse or touchpad input.

While certain embodiments of the invention have been described herein in detail for purposes of clarity and understanding, the foregoing description and Figures merely explain and illustrate the present invention and the present invention is not limited thereto.

1. A computer-implemented method for generating content using a graphical web content builder tool for dynamic serving by a web server, the method comprising:
generating a plurality of related non-responsive web content layouts, each comprising related content items and optimized for display on different client devices;
selectably linking and unlinking the web content layouts in response to user input provided using the web content builder tool, without automatically modifying content items on related web content layouts as a result of transitioning between a linked state and an unlinked state;
while the content layouts are linked: for each of one or more content items manually added to one of the web content layouts in response to user input provided using the builder tool, automatically propagating a family member content item to each of the other related web content layouts;
while the content layouts are unlinked: manually adding one or more content items to one of the web content layouts in response to user input provided using the builder tool, without automatically propagating a family member content item to any of the other related web content layouts.

2. The method of claim 1, in which the automatically propagated family member content items share common content with the manually added content item.

3. The method of claim 2, in which the automatically-propagated family member content items have one or more attributes that differ from the manually added content item.

4. The method of claim 3, in which each of the related layouts has a different size; and
the one or more attributes of the automatically-propagated family member content items that differ from the manually added content item include the content item size, and
the content item size of the automatically propagated content items is automatically modified based on the size of the layout onto which the content items are automatically propagated, as compared to the size of the layout onto which the manually added content item is added.

5. The method of claim 1, in which the step of selectably linking and unlinking the web content layouts comprises selecting a link indicia within a graphical user interface of the builder tool.

6. The method of claim 1, further comprising the subsequent step of dynamically serving the web content by the web server, by:
receiving an inbound query; and
serving one of the plurality of related web content layouts based on evaluation of metadata within the inbound query.

7. The method of claim 6, in which the plurality of related web content layouts comprise a first layout for viewing on personal computer devices, a second layout for view on tablet computing devices, and a third layout for viewing on mobile phones;
and in which the metadata within the inbound query comprises display size and browser type.

8. The method of claim 1, further comprising the step of:
only while the content layouts are linked: modifying an attribute of a content item on one or more of the web content layouts using a builder tool, and automatically propagating the attribute change to family member content items.

9. The method of claim 8, in which the attribute change is automatically propagated to family members without modification.

10. The method of claim 8, in which the attribute change is a size change automatically propagated to family members proportionally to the size of the layout within which the family member resides.

11. The method of claim 1, further comprising:
while the content layouts are unlinked, providing a manual content item propagation mechanism within the graphical web content builder tool, which can be applied by a user to a selected content item within a selected layout to propagate family members of the selected content item to one or more other related layouts.
